(19) United States
(12) Patent Application Publication
(10) Pub. No.: US 2006/0124768 A1
(43) Pub. Date: Jun. 15, 2006

(54) Apparatus and process for the surface coating of workpieces

(75) Inventors: Theo Hartmann, Erlangen (DE); Thomas Sulzbach, Weisendorf (DE); Christoph Richter, Furth (DE); Hans-Jurgen Ludge, Jena (DE); Oliver Krause, Erlangen (DE)

Correspondence Address: BACHMAN & LAPOINTE, P.C., 900 CHAPEL STREET, SUITE 1201, NEW HAVEN, CT, 06510, US

(73) Assignee: NanoWorld AG

(21) Appl. No.: 11/285,097

(22) Filed: Nov. 22, 2005

(30) Foreign Application Priority Data
Dec. 15, 2004 (DE) 20 2004 019476.7

(51) Int. Cl. B05B 1/28; B05B 7/04; A62C 31/00

(52) U.S. Cl. 239/290; 239/291; 239/398

(57) ABSTRACT

An apparatus (1) and a process for the surface coating of workpieces (3), having an applicator nozzle (2) for applying a coating agent to a surface of the workpiece (3) which is to be coated, and having a suction device for discharging the air laden with coating agent vapors and/or coating agent mists, wherein the applicator nozzle (2) and the workpiece (3) are movable relative to one another. A suction bell (4), which engages over an applicator nozzle opening (9) of the applicator nozzle (2) and is rigidly connected to an applicator nozzle wall (14) of the applicator nozzle (2), is arranged downstream of the applicator nozzle (2). The suction bell (4) is a short distance from the workpiece (3) and comprises an inner bell (5) and an outer bell (6), the inner bell (5) delimits a spraying space (7) and the outer bell (6) forms a suction space (8) with a suction intake opening (10) between itself and the inner bell (5).

### BACKGROUND OF THE INVENTION

The invention relates to an apparatus and a process for the surface coating of workpieces, having an applicator nozzle for applying a coating agent to that surface of the workpiece which is to be coated, and having a suction device for discharging the air laden with coating agent vapors and/or coating agent mists from a spraying space, it being possible for the applicator nozzle and the workpiece to be moved relative to one another.

Coating devices which are used for the fully automated coating of objects with resists or similar coating agents are generally installed in spray booths which are open on one side or are completely closed. Walls, ceilings and floors of spray booths of this type are exposed to considerable soiling, since it is impossible to prevent some of the spray mist which is sprayed past an object to be coated being deposited on the walls of the booth. The resultant, periodically required cleaning work entails long machine shutdown times and high cleaning costs. Furthermore, some of the spray mist which rebounds from the object to be coated is deposited on the surface which has already been coated, which has an adverse effect on the coating results. It is particularly disadvantageous in this context that the surface is not completely smooth, but often has an “orange peel” effect, and consequently for many intended applications, especially in semiconductor technology, the surface quality achieved is inadequate as a result of excessive fluctuations in the layer thickness.

It is customary for the air, which may also be laden with pollutant-containing solvent vapors, to be sucked out of the spray booth and for the waste air which is sucked out to be passed through filters. The waste air which has been filtered and therefore purified can be released into the environment. A device for discharging polluted waste air must be sufficiently powerful to be able to generate an (albeit slight) subatmospheric pressure in the spraying state. However, significantly higher flow velocities and therefore a significantly higher subatmospheric pressure are required to protect the installation and the object to be coated from the rebounding spray mist by suction of this type. This level of suction is very complex and entails high levels of noise and high operating costs, and moreover would have the drawback that the high flow velocity has an adverse effect on the quality of the coating.

Therefore, the invention is based on the object of proposing a coating apparatus with a suction device for sucking out the spray mist, in which the suction is produced without major technical outlay and without high flow velocities, yet nevertheless as far as possible prevents redeposition of the spray mist on the surface of a workpiece which has already been coated and contamination of the installation by the spray mist. The invention is also based on the object of proposing a process for coating a workpiece using the apparatus according to the invention.

### SUMMARY OF THE INVENTION

The object is achieved by a coating apparatus and a process as described below.

The coating apparatus according to the invention includes a suction bell which is arranged downstream of the applicator nozzle of the coating apparatus. The suction bell engages over an applicator nozzle opening of the applicator nozzle and is rigidly connected to the applicator nozzle of the coating apparatus. The applicator nozzle is arranged above the surface to be coated, at a distance from the workpiece, at an upper end of a spraying space, whereas the suction bell is at only a short distance from the workpiece.

In the coating operation, the applicator nozzle and the suction apparatus are jointly guided over the workpiece surface, with an open end face of the suction bell facing towards the workpiece and acting as a suction nozzle. The suction bell is connected to a suction installation and sucks out the spray mist in punctiform fashion directly at the coating site. The suction bell does not have to be of the typical bell shape, but rather may also be designed in the shape of a pot with a cylindrical or polygonal lateral surface.

An advantageous configuration of the invention provides for the suction bell to comprise an inner bell and an outer bell which are spaced apart from one another. The inner bell and the outer bell preferably engage coaxially over one another and are connected to an applicator nozzle wall of the applicator nozzle. End faces of the inner and outer bells which face the workpiece can be aligned with one another. The spraying results can be influenced by varying the distance between the end face and the workpiece. For example, if the end face of the inner bell is set back, it is possible to increase the suction volume. The outer bell forms a suction space for sucking out the spray mist between itself and the inner bell, and the inner bell forms a spraying space for punctiform coating of the workpiece.

During the coating operation, the coating apparatus is guided a short distance over that surface of the workpiece which is to be coated. However, it is also possible for that surface of the workpiece which is to be coated to be guided under the coating apparatus. The virtually closed spraying space of the inner bell produces a local atmosphere which is positive for the coating and is substantially independent of the ambient conditions. The spray mist which emerges through the gap between the inner bell and the workpiece surface is sucked out through the suction space of the outer bell. The droplet size of the spray mist which emerges from the applicator nozzle opening can be influenced by the suction rate and the subatmospheric pressure extending into the spraying space.

It is advantageous for a suction intake opening to be formed between the end faces, facing the workpiece, of the outer bell and the inner bell. The suction intake opening is annular in form and oriented approximately parallel to the workpiece surface.

An advantageous refinement of the invention provides for the suction intake opening of the suction bell to be arranged above the workpiece so as to form air gaps at the edge side, with the total passage area through the air gaps approximately corresponding to the suction intake area. The distance between the suction intake opening and the workpiece surface allows the flow velocity and therefore the redeposition of the spray mist on the coated surface of the workpiece to be influenced.

According to a preferred refinement, at least one connection piece, via which the suction bell is connected to a suction installation, is arranged at the outer bell. The connection piece has an opening leading to the suction space of the suction bell. The connection piece may be provided at a lateral surface of the suction bell or at the end face, facing the applicator nozzle, of the suction bell. It is expedient for the connection piece to be arranged at the lateral surface, with the result that the connections of the suction bell and the applicator nozzle do not get in each other's way.

A preferred refinement of the coating apparatus according to the invention provides for the axis of the applicator nozzle and the axis of the suction bell to be aligned with one another and for it to be possible for the suction bell and the workpiece to move parallel relative to one another. In this case, the axis of the coating apparatus may be arranged perpendicularly or at an angle to the surface of the workpiece.

According to the process according to the invention, the application of the coating agent to the workpiece is substantially carried out in the following three steps:

local application of a coating agent to that surface of the workpiece which is to be coated by means of an applicator nozzle arranged above the workpiece at an upper end, remote from the workpiece, of a mobile spraying space;

moving the applicator nozzle and/or the workpiece relative to one another, so that the applicator nozzle is guided over the entire surface of the workpiece which is to be coated; and

sucking out air laden with coating agent vapors and/or coating agent mists in punctiform fashion at the current coating site by means of a suction device, the suction device being at a short distance from the workpiece.

Preferably, the air which is laden with coating agent vapors and/or coating agent mists is discharged from a mobile spraying space, which is delimited by an inner bell of a suction bell of the suction device, into a suction space of the suction bell, which is arranged between the inner bell and an outer bell which engages over the inner bell. For this purpose, the suction bell is moved over the workpiece at a short distance from the latter, with end faces of the outer bell and the inner bell which face the workpiece between them forming a suction intake opening which is oriented approximately parallel to that surface of the workpiece which is to be coated. The air which is laden with coating agent vapors and/or coating agent mists is discharged from the spraying space into the suction space through air gaps which are arranged at the edge side of the suction intake opening between the suction bell and the workpiece. The suction bell, together with the applicator nozzle, is guided over that surface of the workpiece which is to be coated, these components being arranged with their center axes aligned with one another, and the suction bell engaging over the applicator nozzle, and the suction intake opening of the suction bell being moved parallel to that surface of the workpiece which is to be coated.

A preferred use of the apparatus according to the invention is in spray coating systems for the electronics industry. This apparatus can be used to spray resists, passivation coatings or the like onto sheet-like workpieces, such as for example circuit boards, multiple inner layers, hybrids, wafers and LCDs. That part of the spray mist which rebounds from the object to be coated is sucked out in punctiform fashion directly at the coating site and cannot be deposited on the surface which has already been coated, which improves the coating results. A particular advantage in this context is that the surface is completely smooth, in particular preventing the formation of an “orange peel” structure. The result is a sufficient surface quality and low levels of fluctuation in the layer thickness, in particular for microelectronic circuits.

### BRIEF DESCRIPTION OF THE DRAWINGS

In the text which follows, the invention is explained in more detail on the basis of two exemplary embodiments illustrated in the drawing. Further advantageous features of the invention are disclosed in the drawing and in the detailed description thereof. In the drawing:

FIG. 1 shows a sectional illustration of the coating apparatus according to the invention with a center axis oriented perpendicular to the workpiece surface; and

FIG. 2 shows a sectional illustration of the coating apparatus according to the invention with the center axis inclined with respect to the workpiece surface.

### DETAILED DESCRIPTION

The coating apparatus 1 according to the invention illustrated in the drawings is intended for the surface coating of planar workpieces 3 with a viscous coating agent. The coating agents (not shown) are applied to that surface of the workpiece 3 which is to be coated using an applicator nozzle 2. The spray mist (not shown), after it has emerged from an applicator nozzle opening 9, is sprayed onto a surface of the workpiece 3. After the spray mist has rebounded from the surface of the workpiece 3, the air laden with the spray mist is sucked out and discharged by a suction installation (not shown).

The coating apparatus 1 is installed in a coating installation (not shown), which moves the applicator nozzle 2 over the workpiece 3 or the workpiece 3 under the applicator nozzle 2. A suction bell 4 for punctiform suction of the spray mist which rebounds from the workpiece 3 is arranged in front of the applicator nozzle 2. The suction bell 4 is rigidly connected to an applicator nozzle wall 14 of the applicator nozzle 2 and is guided over the workpiece 3 together with the applicator nozzle 2. It is in a cup-like form and engages over an applicator nozzle opening 9 of the applicator nozzle 2. The suction bell 4 is arranged concentrically with the center axis of the applicator nozzle 2, with the open end of the suction bell 4 facing toward the workpiece 3.

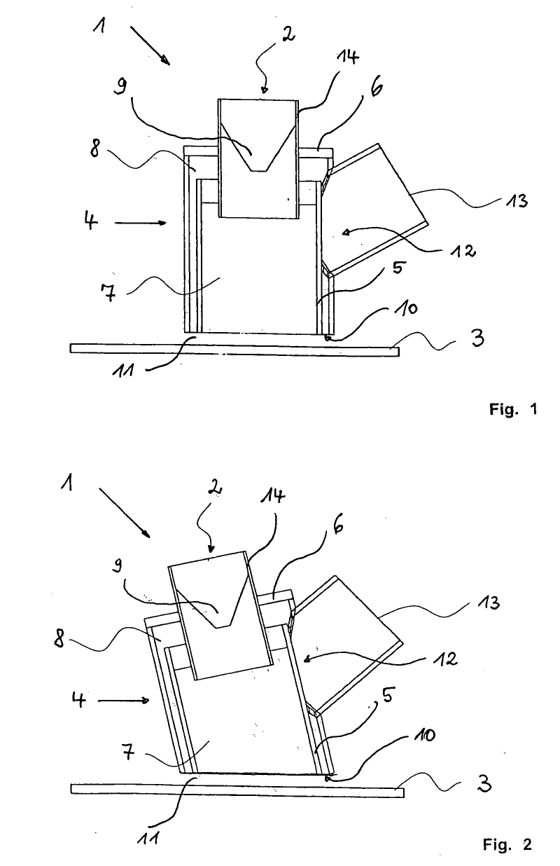

FIG. 1 shows a first embodiment, in which the suction bell 4 has a cylindrical lateral surface, with the center axis of the suction bell 4 oriented perpendicular to the workpiece 3, and the suction bell 4 being guided in this orientation over the surface of the workpiece 3. FIG. 2 shows a second embodiment, in which the center axis of the suction bell 4 is at an angle other than 90° to the surface of the workpiece 3.

The suction bell 4 comprises an inner bell 5 and an outer bell 6, which are spaced apart from one another. The outer bell 6 engages over the inner bell 5, with their end faces facing the workpiece 3 aligned with one another. A suction space 8 is formed by the space between the outer bell 6 and the inner bell 5. The interior of the inner bell 5 forms a spraying space 7 which the spray mist emerging from the applicator nozzle opening 9 of the applicator nozzle 2 enters. A suction intake opening 10, through which the air of the spraying space 7 which is contaminated with the spray mist (not shown) is sucked out, is provided at that end face of the suction bell 4 which faces the workpiece 3. The suction opening 10 is formed between the end faces, facing the workpiece 3, of the outer bell 6 and the inner bell 5. The suction intake opening 10 is annular in form and arranged coaxially around the center axis of the spraying space 7. The suction opening 10 of the suction bell 4 is arranged a short distance above the workpiece 3 and is oriented approximately parallel to the surface of the workpiece 3, and is guided over the workpiece at a short distance from it during the coating operation. The distance between the suction intake opening 10 and the workpiece 3 results in the formation of edge-side air gaps 11 around the suction opening 10, through which air gaps the spray mist is passed into the suction space 3. The distance between the end faces of the outer bell 6 and the inner bell 5 and the workpiece 3 is such that the total passage area of the air gaps 11 approximately corresponds to the suction intake area of the suction intake opening 10. The outer bell 6 has a connection piece 13 which penetrates through the lateral surface of the outer bell 6 and is connected to a suction installation (not shown). After the waste air laden with the spray mist has left the spraying space 7, the waste air flows through the air gaps 11 formed between the inner bell 5 and the workpiece 3 via the suction opening 10 into the suction space 8 and is sucked out of the suction space 8 by the suction installation via an opening 12 of the connection piece 13.

What is claimed is:

1. An apparatus (1) for the surface coating of workpieces (3), comprising an applicator nozzle (2) for applying a coating agent (2) to a surface of the workpiece (3) which is to be coated, and having a suction device for discharging air laden with coating agent vapors and/or mists from a spraying space (7) wherein the applicator nozzle (2) and the workpiece (3) are movable relative to one another a suction bell (4), which engages over an applicator nozzle opening (9) of the applicator nozzle (2) and is rigidly connected to an applicator nozzle wall (14) of the applicator nozzle (2), is arranged downstream of the applicator nozzle (2), the applicator nozzle (2) being arranged at a first distance from the workpiece (3) at an upper end of the spraying space (7), and the suction bell (4) being at a second distance from the workpiece (3), wherein the second distance is less than the first distance.

2. An apparatus according to claim 1, wherein the suction bell (4) comprises an inner bell (5) and an outer bell (6) which engages over the inner bell (5), the two bells being spaced apart from one another, the outer bell (6) forming a suction space (8) between itself and the inner bell (5), and the inner bell (5) forming the spraying space (7), the two bells are connected to the applicator nozzle wall (14) of the applicator nozzle (2).

3. Apparatus according to claim 2, wherein a suction intake opening (10) having a suction intake area is formed between the end faces of the outer bell (6) and the inner bell (5) which face the workpiece (3).

4. Apparatus according to claim 3, wherein the suction intake opening (10) of the suction bell (4) is oriented approximately parallel to the surface of the workpiece (3).

5. Apparatus according to claim 2, wherein at least one connection piece (13), by which the suction bell (4) is connected to a suction installation, is arranged at the outer bell (6).

6. Apparatus according to claim 4, wherein the suction intake opening (10) is arranged above the workpiece (3), wherein the end faces form air gaps (11) having a total passage area, the total passage area through the air gaps (11) corresponds approximately to the suction intake area of the suction intake opening (10).

7. Apparatus according to claim 2, wherein a center axis of the applicator nozzle (2) and a center axis of the suction bell (4) are aligned with one another, wherein the suction bell (4) and the workpiece (3) can move relative to one another parallel to the surface of the workpiece (3).

8. A process for the surface coating of workpieces (3), using an applicator nozzle (2) for applying a coating agent to that surface of the workpiece (3) which is to be coated, and using a suction device for discharging the air laden with coating agent vapors and/or coating agent mists from a spraying space (7), wherein the applicator nozzle (2) and the workpiece (3) are moveable relative to one another, characterized by the following steps:
(a) local application of a coating agent to that surface of the workpiece (3) which is to be coated by means of an applicator nozzle (2) arranged above the workpiece (3) at an upper end, remote from the workpiece (3), of a mobile spraying space (7);
(b) moving the applicator nozzle (2) and/or the workpiece (3) relative to one another, so that the applicator nozzle (2) is guided over the entire surface of the workpiece (3) which is to be coated; and
(c) sucking out air laden with coating agent vapors and/or coating agent mists in punctiform fashion at the current coating site by means of a suction device, the suction device being at a short distance from the workpiece (3).

9. A process according to claim 8, including discharging the air which is laden with coating agent vapors and/or coating agent mists from a mobile spraying space (7), wherein the spraying space is delimited by an inner bell (5) of a suction bell (4) of the suction device and into a suction space (8) of the suction bell (4), the suction space (8) is arranged between the inner bell (5) and an outer bell (6) which engages over the inner bell (5).

10. A process according to claim 9, including moving the suction bell (4) over the workpiece (3) at a short distance from the latter, wherein end faces of the outer bell (6) and the inner bell (5) which face the workpiece (3) form a suction intake opening (10) which is oriented approximately parallel to a surface of the workpiece (3) which is to be coated.

11. A process according to claim 9, including discharging from the spraying space (7) into the suction space (8) through air gaps (11) which are arranged at an edge side of the suction intake opening (10) between the suction bell (4) and the workpiece (3) the air which is laden with coating agent vapors and/or coating agent mists.

12. A process according to claim 9, including guiding the suction bell (4) together with the applicator nozzle (2) over a surface of the workpiece (3) which is to be coated, wherein the suction bell and applicator nozzle have center axes aligned with one another, and the suction bell engages over the applicator nozzle, and moving the suction intake opening (10) of the suction bell (4) parallel to the surface of the workpiece (3) which is to
